(19) United States
(12) Patent Application Publication
(10) Pub. No.: US 2022/0372814 A1
(43) Pub. Date: Nov. 24, 2022

(54) ARTICLE FOR SEALING OBJECTS

(71) Applicant: ULTRAFAB, INC., Farmington, NY (US)

(72) Inventors: Alan J. DeMello, Newmarket, NH (US); David M. Loughney, Phelps, NY (US); Todd M. Clemons, Canandaigua, NY (US)

(21) Appl. No.: 17/750,321

(22) Filed: May 21, 2022

Related U.S. Application Data
(60) Provisional application No. 63/191,717, filed on May 21, 2021.

(51) Int. Cl. E06B 3/96; E06B 7/23; B32B 27/08; B32B 27/32; B32B 3/26

(52) U.S. Cl. CPC E06B 3/9616; E06B 7/2314; B32B 27/08; B32B 27/32; B32B 3/266; B32B 2405/00

(57) ABSTRACT

The invention provides for an article of manufacture, being a sealing pad (410a, 410b, 510a, 510b, 610a) for providing resistance (obstruction) to infiltration of matter and/or energy into pre-manufactured products, including such as windows, doors and appliances. The invention also provides for a method of employing the sealing pad (410a, 410b, 510a, 510b, 610a) to provide location targeted and value added obstruction (resistance) to such infiltration into pre-manufactured products, in response to performance of infiltration testing.

This document is a United States Non-Provisional utility patent application under statute 35 U.S.C. 111(a), that claims priority and benefit to co-pending U.S. (utility) provisional patent application having Serial No. (63/191,717), (Confirmation No. 8976), (Docket No. ULB-038P), that was filed on May 21, 2021, and that is entitled “IMPROVED ARTICLE OF WEATHER STRIPPING”, and which is incorporated herein by reference in its entirety, for any and all purposes.

### PATENT APPLICATION(S) INCLUDING RELATED SUBJECT MATTER

This document includes subject matter generally related to U.S. Patent Publication No. 2013/0236684 to Loughney et al., that was published Sep. 12, 2013 and entitled “Pile Weatherstripping . . . Polypropylene”, and generally related to U.S. Patent Publication No. 2019/0078379 to Loughney et al., that was published Mar. 14, 2019 and entitled “Article of Weather Stripping”. All of the aforementioned patents, patent publications and other published documents (publications) are herein incorporated by reference in their entirety.

### BACKGROUND OF THE INVENTION

Weather stripping is an article of manufacturing that is designed to provide obstruction against infiltration matter and energy, such as including that of air, dust and water through openings for example, where such as openings reside in vehicles, doors and windows, for example. Weather stripping is typically manufactured into strips having dimensions that are long and narrow. Some weather stripping is designed as pile weather stripping. Pile weather stripping includes a plurality of protruding filaments that extend away from a backing portion of the weather stripping. The plurality of protruding filaments is collectively referred to as a pile of filaments. Some weather stripping is designed as being other than pile weather stripping, and is designed to not include protruding filaments. The discussion above is merely provided for general background information and is not intended to be used as an aid in determining the scope of the claimed subject matter.

### BRIEF DESCRIPTION OF THE INVENTION

The invention provides for an improved article of manufacturing and method of use for obstruction (resistance to) infiltration of matter and energy into various types of manufactured products, where such matter includes air, dust and water for example, and such energy includes heat, light and sound, for example. Such types of manufactured objects include windows, doors and appliances, for example.

More specifically, the invention provides sealing pads, being an inventive type of weather stripping, that is dimensioned (cut, contoured, shaped and sized) in a customized manner to provide obstruction (resistance) to infiltration of matter and energy within manufactured products. These sealing pads are designed in a manner that is unlike the design of traditional weather stripping.

For example, the sealing pads are designed to be selectively applied and adhered to targeted locations with a manufactured product, and as applied, provide a longer path of obstruction (resistance) to infiltration of matter and energy along a path of such infiltration of matter and energy into the manufactured product. Furthermore, these sealing pads are designed to be value added to pre-manufactured products, and are not required to be designed into or applied to such pre-manufactured products prior to or during the manufacture of such products.

This brief description of the invention is intended only to provide an overview of subject matter disclosed herein according to one or more illustrative embodiments, and does not serve as a guide to interpreting the claims or to define or limit the scope of the invention, which is defined only by the appended claims.

### BRIEF DESCRIPTION OF THE DRAWINGS

So that the manner in which the features of the invention can be understood, a detailed description of the invention to certain embodiments of the invention is provided herein, some of which are illustrated in the accompanying drawings. It is to be noted, however, that the drawings illustrate only certain embodiments of this invention and are therefore not to be considered limiting of the scope of the invention, for the scope of the invention can encompass other effective embodiments.

The drawings are not necessarily to scale. The emphasis of the drawings is generally being placed upon illustrating the features of certain embodiments of the invention. In the drawings, like numerals are used to indicate like parts throughout the various views. Differences between like parts may cause those parts to be indicated with different numerals. Unlike parts are indicated with different numerals. Thus, for further understanding of the invention, reference can be made to the following detailed description, read in connection with the drawings in which:

FIGS. 1A-1D collectively illustrate embodiments of different types of weather stripping.

FIG. 2 illustrates an interior view of an embodiment of an installed window.

FIGS. 3A-3B illustrate characteristics of a generic window sash.

FIGS. 4A-4F illustrate embodiments of sealing pads that are employed for reducing infiltration of matter and energy at locations along a perimeter of different embodiments of a top (upper) sash of a window.

FIGS. 5A-5C illustrate embodiments of sealing pads that are employed for reducing infiltration of matter and energy at locations along a perimeter of different embodiments of a bottom (lower) sash of a window.

FIGS. 6A-6D illustrate characteristics of a sash surface and an embodiment of a sealing pad that is employed for reducing infiltration of matter and energy along a sash surface including such characteristics.

### DETAILED DESCRIPTION OF THE INVENTION

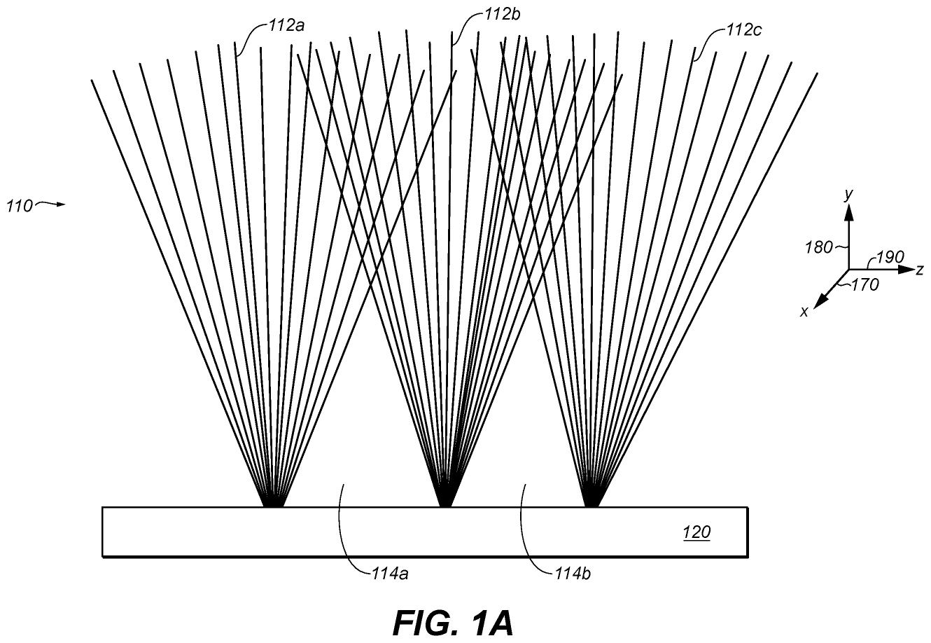

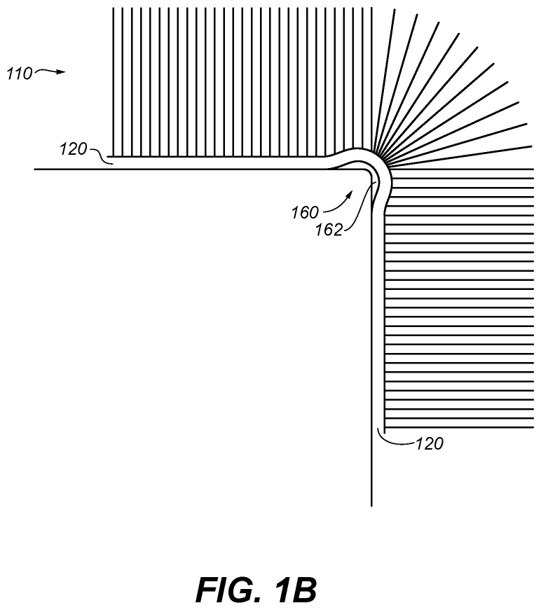

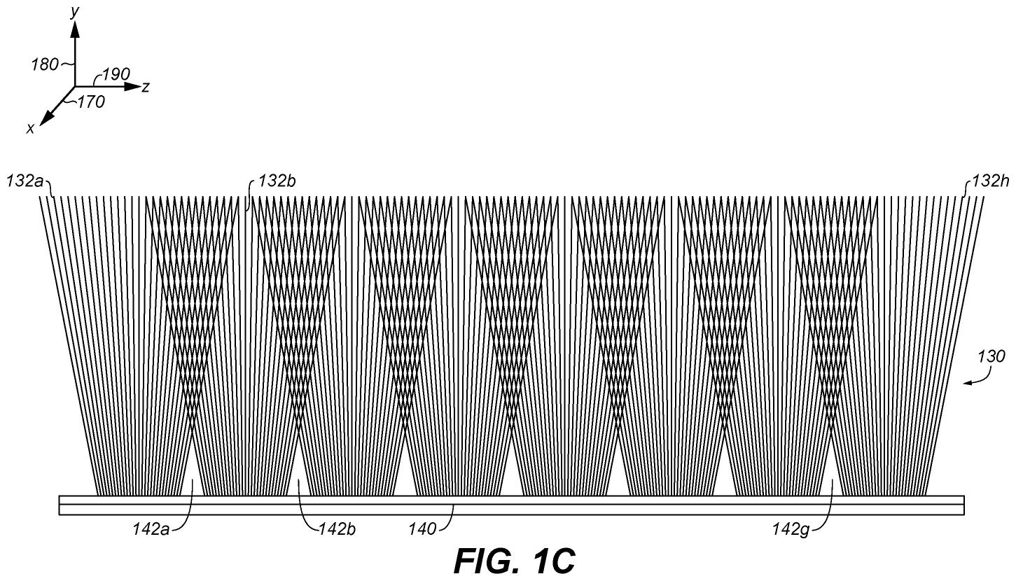

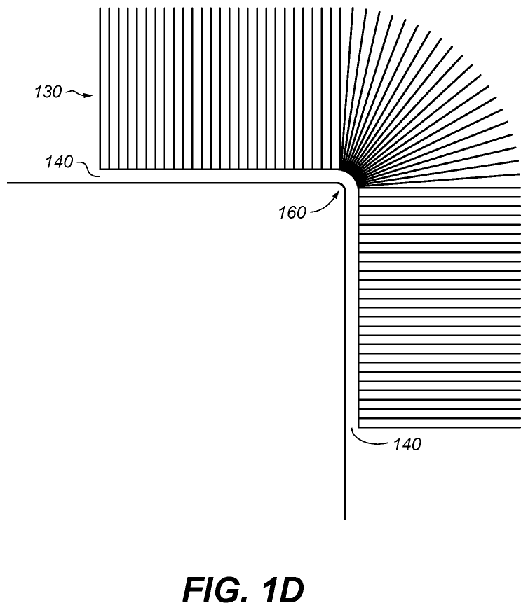

FIGS. 1A-1D collectively illustrate embodiments of different types of weather stripping. FIG. 1A illustrates a first embodiment, being a traditional (prior art) article of weather stripping that includes a backing layer 120 and a pile of filaments 110. In this embodiment, the filaments are attached to the backing layer 120 via ultrasonic welding. In other embodiments, such filaments can be attached to the backing layer by other means, such as via chemical adhesion or via weaving of the filaments through the backing layer 120, for example. As shown, each of the clusters of filaments 112a-112c, protruding upward from the backing layer 120, are also referred to herein as a group of filaments 112a-112c or as a filament group 112a-112c. These filaments 112a-112c are referred to herein as a filament layer 112. The backing layer 120 is also referred to herein as a structural support layer 120 or as a support layer 120.

In this embodiment, the backing layer 120 has a thickness of about 30/1000 of an inch, which is typical for traditional weather stripping. Each group of filaments 112a-112c spreads apart (blooms) along a horizontal plane that is oriented parallel to a combination of the X 170 and Z 190 axes. Each filament group 112a-112c spreads (blooms) by an amount that is a function of its distance away from the backing layer 120. The distance being measured from the backing layer 120 from which each filament group 112a-112c is attached.

As shown, there is an air gap 114a-114b that is located along the upper surface of the backing layer 120 and that is located between each adjacent pair of filament groups 112a-112c, within the set filament groups 112a-112c. Each air gap is referred to herein as a “corn row” 114a-114b. A lower surface of the backing layer faces in an opposite direction away from the filament groups 112a-112c. This lower surface of the backing layer is also referred to herein as the exposed surface or side or as the exterior surface or side of the backing layer.

Corn row 114a is located in between filament grouping 112a and 112b and has a long dimension that is directed parallel the X axis 170, as shown here. Corn row 114b is located in between filament grouping 112b and 112c and also has a long dimension that is directed parallel the X axis 150. These corn rows 114a-114b are being viewed from a viewing direction that is parallel to the X axis 170. In this embodiment, corn rows are not visible when being viewed from a viewing direction that is parallel to the Z axis 190 direction.

Weather stripping is employed for the purpose of obstructing a flow of air, water or other fluids and/or particulates through a passageway. Typically, a flow of air carries other types of matter, such as dust and water, for example. Such a passageway can reside within various manufactured products, such as within an automobile, or within a door or within a window frame. Some passageways are also referred to herein as voids or crevices.

Typically, weather stripping is manufactured into strips having a long dimension that is parallel to the X axis 170. Generally, weather stripping is dimensioned to be long and narrow in shape. The long (length) dimension of weather stripping 110 being typically wound around a spool in lengths of hundreds of feet, and as a result, individual weather strips can be cut from such a spool to a desired length. As referred to herein, the long dimension of this weather stripping 110 is measured parallel to the X axis 170, as shown.

As referred to herein, a width dimension of this weather stripping is measured parallel to the Z axis 190, as shown. In this type of embodiment, being a traditional (prior art) weather stripping, the width of such a weather strip is typically a small fraction of an inch, and approximately a quarter of an inch.

A height (thickness-depth) dimension of a weather strip is also typically a small fraction of an inch, and typically a quarter of an inch or less. As shown here, a thickness (height/depth) dimension of this weather stripping is measured parallel to the Y axis 180.

Note that a thickness of a backing layer 120 of traditional weather stripping, is typically made from a material, such as polypropylene for example, having a thickness of 30/1000 of an inch or greater. When made from polypropylene, being a thermoplastic, the backing layer 120 is extruded into a planar shape, and that forms one solid sheet of plastic upon cooling to room temperature. Such a backing layer 120 is more resistant to bending as compared to a non-traditional type of weather stripping is discussed in association with FIG. 1C.

When a portion of weather stripping is cut and installed into a passageway, such a portion of weather stripping is installed so that the long dimension of any corn rows 114a-114b is disposed perpendicular to the expected flow of matter, such as air or water for example, within that passageway, and also disposed perpendicular to the long dimension of the filaments 112, being parallel to the Y axis 180, that are attached to the weather stripping. The long dimension of such a portion of weather stripping being parallel to the X axis 170 and to the long dimension of the corn rows 114a-114b of that portion of weather stripping. In other words, such weather stripping is preferably installed so that the flow of air and water, for example, is directed parallel to the Z axis 170 of the weather stripping, as shown in this figure.

FIG. 1B is a simplified illustration of bending traditional weather stripping of FIG. 1A around a corner of an object, such as for example, around a corner 160 of a window sash 310.

The backing layer 120 is made from extrusion of a thermoplastic (plastic) material, such as polypropylene, into a planar shape, forming a sheet. Cooling of the thermoplastic material forms a sheet that constitutes the backing layer 120. Upon cooling, this sheet hardens into a room temperature plastic that resists bending. Using an index finger and a thumb finger of a human hand for example, and employing finger strength of generating a force of two pounds, for example, such a force is insufficient to cause this backing layer 120 to make contiguous physical contact for a distance of one inch on both perpendicular (right angle) surfaces that surround the corner 160 of the window sash 310.

Such lack of a contiguous physical contact between the backing layer 120 and the surfaces of the sash, causes one or more air gaps 162 to form that are visible to the human eye. Such air gaps 162, being formed between the backing layer 120 of the traditional weather stripping 110 and the perpendicular (orthogonal) surfaces that surround the corner 160 of the window sash 310.

Because such a substantial amount of force would be required just to attempt to cause contiguous physical contact between the traditional weather stripping 110 and the surfaces of the sash surrounding the corner 160 of the sash 310, visible air gaps 162 are typically formed, even when an adhesive is employed in an attempt to increase an amount of bonding force between the traditional weather stripping 110 and the surfaces of the sash that surround the corner 160 of the sash 310.

FIG. 1C illustrates a side view of a second embodiment of weather stripping 130, being a newer and more recently developed type of non-traditional weather stripping, also referred to herein as a sealing pad type of weather stripping. A sealing pad is preferably made dimensioned (cut, contoured, shaped and sized) from material referred to herein as a dust plug.

This second embodiment of weather stripping 130 includes wider clusters of filaments, and narrower (reduced) distance of separation between each cluster of filaments 132a-132h. This embodiment of weather stripping 130 includes a backing layer 140 and a plurality of filament clusters 132a-132h that are attached to the backing layer 140. These clusters of filaments are also referred to herein collectively as a pile of filaments 132 or as a filament pile 132. As shown, the filaments 132 protrude upward and away from the backing layer 140, in a direction that is parallel to the Y axis 160. These filaments are also referred to herein as protrusions 132, from the backing layer 140.

In this example embodiment, the backing layer 140 and the filaments 132 are both made from the same type of material, being a polypropylene based material, and are attached to each other via a process of ultrasonic welding. As a result, the backing layer 140 and the filaments 132 are ultrasonically welded (attached) to each other.

Unlike that of traditional weather stripping 110, the backing layer 140 for this second embodiment of weather stripping 130, is preferably made from compressing a plurality of thin fibers that are each made from a polypropylene based material, into a compressed material that is less dense and more flexible, and less resistant to bending, in addition to being thinner, than the backing layer 120 within the traditional weather stripping 110 of FIG. 1A.

Also, with respect to this second embodiment of weather stripping 130, the volume of space that is occupied by the corn rows 142a-142g is much smaller in comparison to that of traditional weather stripping, as shown in FIG. 1A. As a result, there is no requirement to necessarily align the direction of the corn rows 142a-142g of this type of weather stripping 130 to be perpendicular with the expected direction of the flow of air and water into the window, within which this second embodiment of weather stripping 130 is to be installed.

Preferably, the weather stripping 130 is treated with silicon so as to increase water repellence of the filaments 132 within the weather stripping 130. This characteristic reduces an amount of moisture that can accumulate within the filaments 132 over time.

As shown here, the volume of space of the corn rows 142a-142g has a long dimension that is aligned along the X axis 150. In other embodiments, the long dimension of the corn rows 142a-142g can instead be directed diagonal to the X 150 axis, while remaining parallel with the geometric plane that is defined by the combination of the X 150 and Z170 axes. In this type of embodiment, which is also referred to herein as an embodiment having diagonal or zagged corn rows, a cross-sectional view of this weather stripping 130 that is directed parallel to the X axis 150 (as shown here) would expose a wider cross-section of each cluster of the filaments 132a-132h. In a variation of this embodiment, such diagonal directed corn rows 142a-142g can be sequenced to change from one diagonal direction to another diagonal direction, in a zig-zagging manner.

In this example embodiment, the filaments 132 are approximately (about) 200/1000 inches in length (height) and the backing layer 140 is approximately (about) 15/1000 in thickness (height), causing the total height of this brush sealing pad 110 to be approximately (about) 215/1000 inches. However, such filaments 132 can be manufactured and customized to be shorter or longer than 200/1000 inches. As for longer, filaments can be manufactured to be 260/1000 inches in length (height) or longer, for example. Note that filaments 132 can also be manufactured to be shorter in length, but shorter filaments 132 can become stiffer can more resistant to bending, which can render such an embodiment of weather stripping less suitable for some applications, including at least some of the applications that are described herein. As for shorter, filaments can be manufactured to be 160/1000 inches in length (height), for example, which would enable a manufactured sealing pad to have a total pre-installed thickness of about 175/1000 inches, and a thickness less than 200/1000 inches as installed onto an object surface, such as a surface of a window sash.

The technology of this second embodiment 130 and recently developed type of weather stripping is described in more detail within the U.S. Patent Publication No. 2019/0078379 to Loughney et al., that was published Mar. 14, 2019 and entitled “Article of Weather Stripping”. The subject matter of this patent publication describes manufacturing of dust plugs. In a described embodiment, a dust plug is made from a polypropylene based backing layer material and a polypropylene based set (pile) of filaments, that are attached to and protrude from the backing layer.

In a preferred dust plug embodiment, the backing layer 140 is made from a non-woven and non-porous polypropylene based material. This backing layer 140 is referred to herein as a polypropylene based non-woven fabric, and/or as a polypropylene based film. A set (pile) of filaments are attached (bonded) to the backing layer via ultrasonic welding. Optionally, filaments can be interleaved and wound around each other to form strands of yarn, and bonded to the backing layer via ultrasonic welding.

This polypropylene based fabric (film) is designed to be a non-porous layer (sheet) of polypropylene based material that functions as a barrier within the sealing pad. This barrier prevents material, including air, water and/or particulates, from passing through the backing layer of the sealing pad, while the sealing pad is attached to an object. Such an object can be a window or door, for example.

Optionally, this barrier can be made from a compression of polypropylene based fibers, that form a non-porous layer of backing material. Or alternatively, this layer is not made from fibers, and is formed as a non-porous and contiguous layer of material, such as through extrusion and molding of polypropylene based material.

However, in less preferred embodiments, the backing material can be made from polypropylene based material that is at least partially woven to form a backing layer, and that is designed as a barrier to resist passage of material, including air, water and/or particulates through the backing layer of a sealing pad.

As referred to herein, a polypropylene based material is a material that substantially includes polypropylene. Polypropylene can be combined with other materials to form a polypropylene based material. As stated herein, a polypropylene based material by volume, is a material that includes at least 30 percent of polypropylene by volume. And as stated herein, a polypropylene based material by weight, is a material that includes at least 30 percent of polypropylene by weight. And as stated herein, a polypropylene based material, unless otherwise stated, is a polypropylene based material that is a polypropylene based material by volume, and/or a polypropylene based material by weight. As defined herein, polypropylene by itself, and not combined with other types of material, is a polypropylene based material.

In other embodiments, the aforementioned thickness of the backing layer 140 and the length of the filaments 132 can vary substantially in relation to this herein described example embodiment. Also, in other embodiments, other types of materials, other than a polypropylene based material and/or other means of attachment between the backing layer 140 and the filaments 132, can be manufactured, dimensioned (cut, contoured, shaped and sized) and employed to form sealing pads that function in a same or similar manner, as described herein.

For example, the U.S. Patent Publication No. 2013/0236684 to Loughney et al., that was published Sep. 12, 2013 and entitled “Pile Weatherstripping . . . Polypropylene”, describes subject matter where filaments made of nylon are attached to a backing layer made partially from polypropylene and partially from another material that is classified as an anhydride modified polypropylene. This anhydride modified polypropylene (AMP) being a type of AMP material having properties for bonding nylon and polypropylene. A blend (mixture) of polypropylene and such an AMP material, forming a polypropylene based material, enables a backing layer made from this blend to bond with filaments made from a nylon material, via ultrasonic welding of the nylon filaments to a backing layer made from this blend. This attachment between such different materials as polypropylene and nylon involves in part, employment of ultrasonic welding. In other embodiments, other materials can be combined with polypropylene to make filaments and/or the backing layer, with or without employing ultrasonic welding.

FIG. 1D is a simplified illustration of bending the second embodiment of non-traditional weather stripping 130 of FIG. 1C around a corner of an object, such as for example, around a corner 160 of a window sash 310.

Using routine hand strength, preferred embodiments of the non-traditional weather stripping (dust plug) can be forced (physically manipulated/oriented) to make continuous wrapping contact on surfaces that surround a corner 160 of a sash 310, and while not leaving air gaps that are visible to the human eye. This exercise is performed by applying a routine amount of hand strength, specifically being two pounds or less of force per hand, to cause contiguous physical wrapping contact between this non-traditional weather stripping 130 and the corner 160 of the sash 310.

In other less preferred embodiments involving less flexible backing layer material, this exercise can be performed with five pounds or less of force per hand. In even lesser preferred embodiments, this exercise can be performed with ten pounds or less of force per hand. In other embodiments, machinery may be required to perform this exercise.

A preferred backing layer 140 of this second embodiment of non-traditional weather stripping, being a non-woven polypropylene material that is made from compressed fibers, is substantially less resistant to bending than the backing layer 120 of the traditional weather stripping of FIGS. 1A-1B.

What this FIG. 1D illustrates, is that unlike traditional weather stripping 110, this non-traditional weather stripping 130 possesses a backing layer 140 that has less resistance to bending so that it can be pressed against, adhered to and installed upon multiple perpendicular (orthogonal) planar surfaces without creating visible air gaps, that would be otherwise caused by resistance to bending of a backing layer of traditional weather stripping.

Also, irregularities along a surface, such as caused by high spots (protrusions) and low spots (cavities) can be covered and adhered to and encapsulated by this weather stripping 130 in order to prevent formation of visible air gaps between the surface and the weather stripping 130. Also, large corn rows and especially those that are aligned with a flow of air and other matter, can cause degrading of the air obstruction performance of the dust plug.

This design feature simplifies installation and reduces time for installation of this non-traditional type of weather stripping, and improves performance of this weather stripping, after installation to enhance the quality of products within which such non-traditional weather stripping is installed.

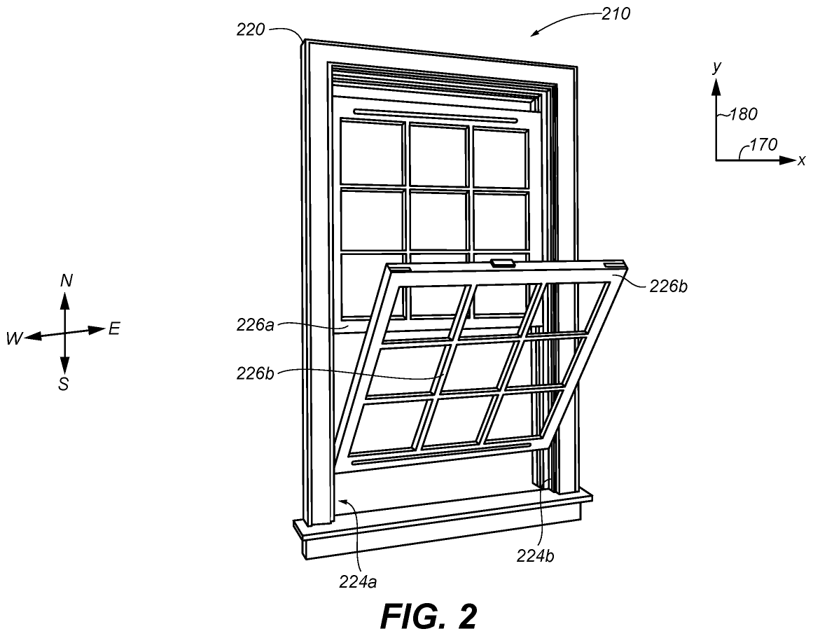

FIG. 2 illustrates an indoor viewing perspective of a window 210 that is installed into a wall of a building structure. This window 210 is a classified as a double hung type of window. A double hung window 210 includes a window frame 220 and includes two sashes 222a-222b, being an upper sash 222a and a lower sash 224b that are disposed within a window frame. Both sashes 222a-222b are each designed to slide along a vertical direction within the window frame 220 as it is installed into a wall of a structure, also referred to herein as the window 210 as it is “installed”. The vertical direction being substantially parallel to a Y axis 180, being in an upwards or in a downwards direction, within the window frame 220 as it is installed. When moved upwards, a sash 222a-222b is also referred to as being moved north, or in a northward direction, and when moved downwards, a sash 222a-222b is also referred to as being moved south, or into a southward direction.

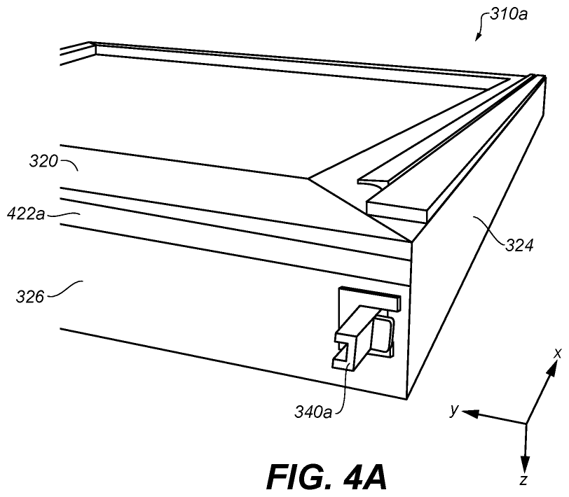

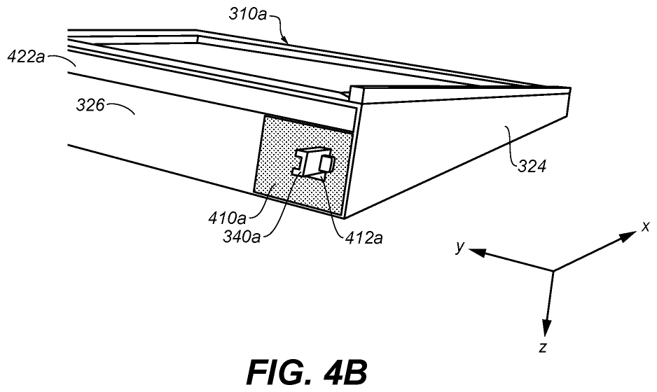

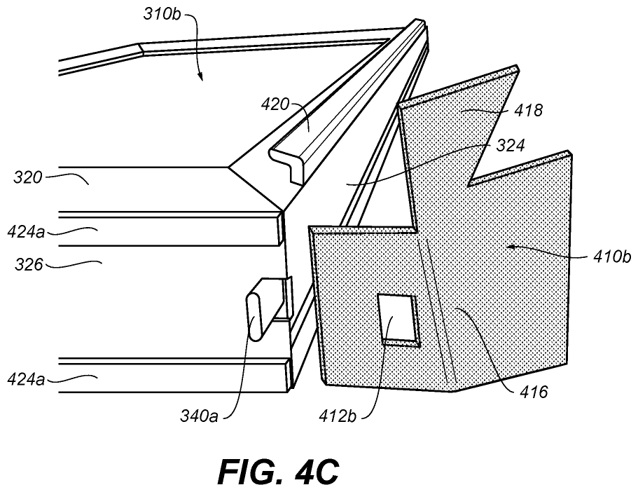

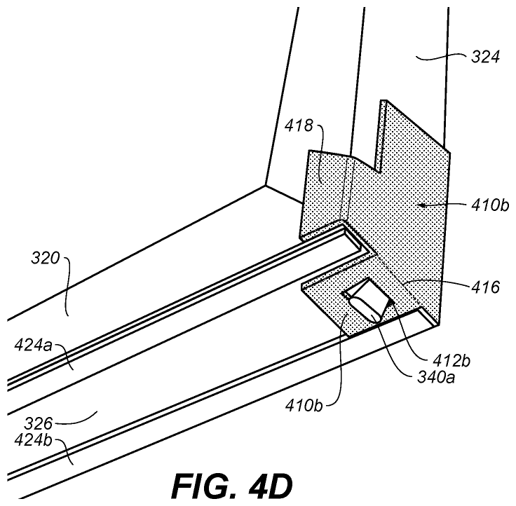

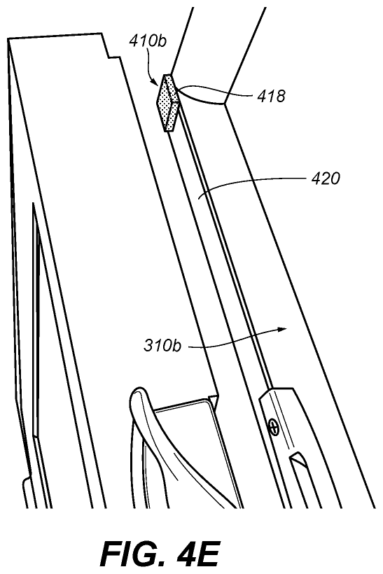

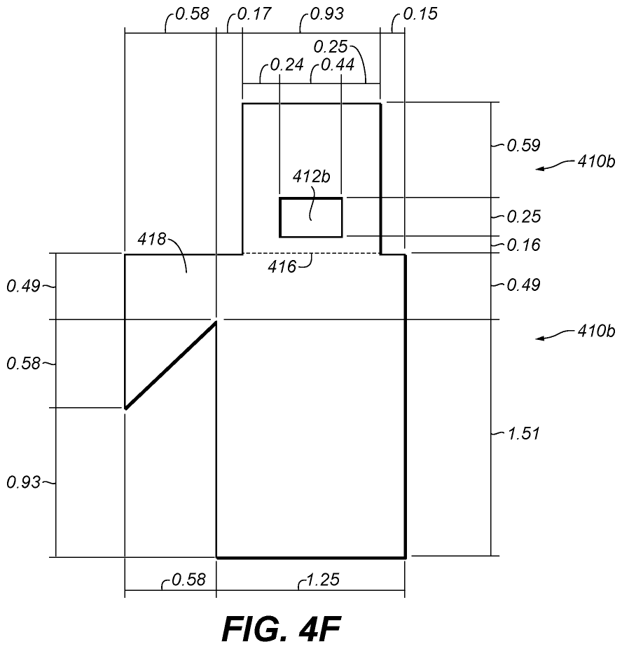

Each sash includes a protruding end portion of a pivot bar (pivot bar protrusion) that protrudes from its lower left hand side and another protruding end portion of a pivot bar (pivot bar protrusion) that protrudes from its lower right hand side. (See FIGS. 4A-4D). Each protruding end of the pivot bar is designed to slide within a grooved (concave) track that is disposed along each of two inside and opposite facing surfaces (jamb liner) 224 of the window frame 220. Each of both of these two inside surfaces face each other. Both of the upper and lower sashes that are installed into the window frame and in between the upper sash 222a and the lower sash 222b. These grooved concave tracks are disposed along each of the left hand side and the right hand side of the window frame 220. Each groove extending in a vertical direction from a bottom portion of the window frame to a top portion of the window frame.

The upper sash 222a, via its two pivot bar protrusions, slides vertically within a first track that is disposed farthest from the viewer of this figure and behind the lower sash. The lower sash 222b, via its two pivot bar protrusions, slides vertically within a second track that is disposed forward of the first track of the upper sash, and closest from the viewer of this figure, with respect to aa viewing perspective of a viewer of this figure. When the upper 222a and lower 222b sashes are slid to a location that minimizes an overlap of each other, a lower perimeter (rail) portion 226a of the upper sash 222a is located close to and nearly touching an upper perimeter (rail) portion 226b of the lower sash 222b.

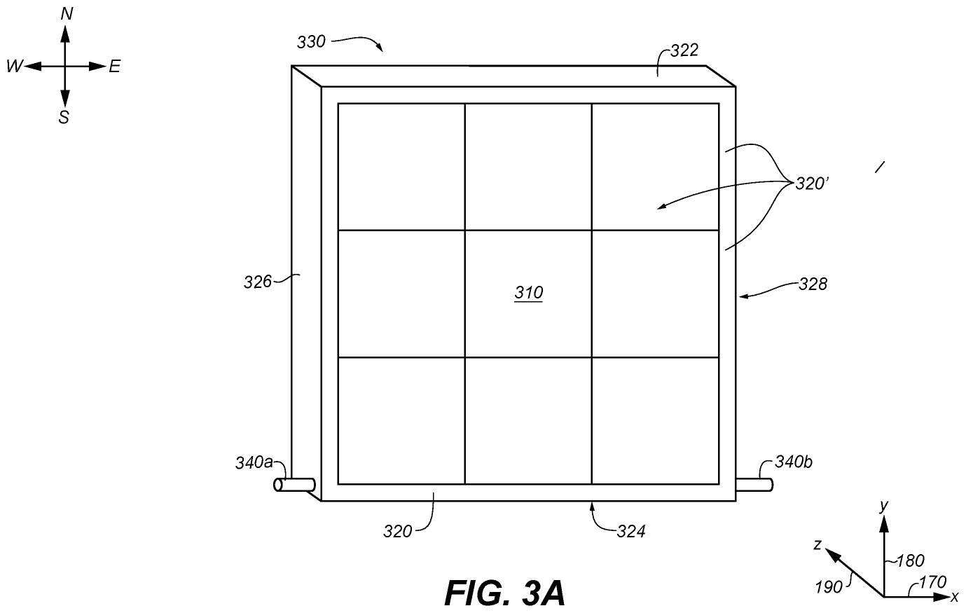

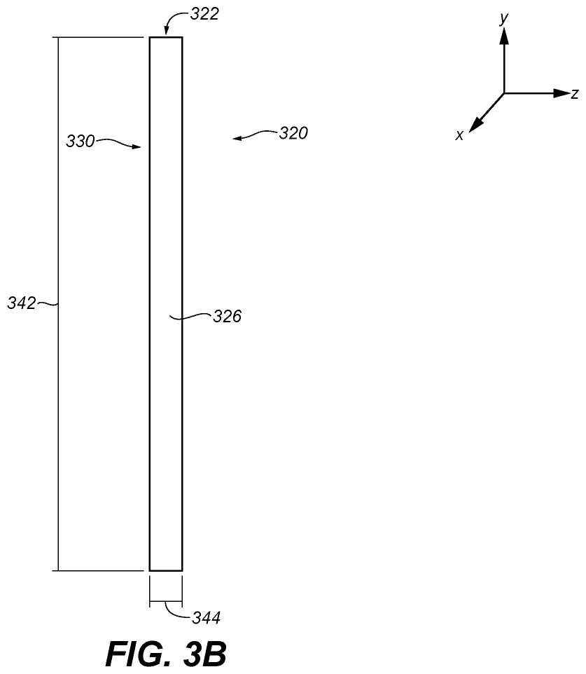

FIGS. 3A-3B illustrate characteristics of a generic window sash. FIG. 3A illustrates a front side view of a window sash 310. A typical window, such as a double hung type of window of FIG. 2, includes a top (upper) sash and a bottom (lower) sash. The window sash 310 shown in this figure is intended to be a generic representation of either a top (upper) or bottom (lower) window sash.

As shown, the window sash 310, which is also referred to herein as a sash 310, includes a front (facing) surface 320, a top (up facing) surface 322, a bottom (down facing) surface 324, and left hand (facing) surface 326, and right hand (facing) surface 328, and a rear (facing) surface 330. The front surface 320 faces towards the viewer of this figure, and the rear surface 330 faces away from the viewer of this figure.

Both of the front surface 320 and the rear surface 330 are each referred to herein as broad side surfaces. The surface area of these broad side surfaces 320, 330 is composed mostly of glass that is surrounded by four rails. These four rails, which form a perimeter of these broad side surfaces, are typically made from wood or made from some other structural type of material, and are attached to each other to form a square or rectangular shaped perimeter of each sash 310.

Each of these four rails possess three exterior surfaces, an exterior front surface 320 that faces towards the viewer of this figure, an exterior intermediate side surface 322-328 that faces 90 degrees away from the viewer of this figure, and an exterior rear surface 330 that faces 180 degrees away from the viewer of this figure.

A top rail includes a top side (intermediate side) surface 322, a bottom rail includes a bottom side (intermediate side) surface 324, a left hand side rail includes a left hand side (intermediate side) surface 326 and a right hand rail includes a right hand side (intermediate side) surface 328. Each of these rail intermediate side surfaces, face in a direction as graphically indicated in this figure, being towards a north, south, west or east direction respectively, and away from the sash 310, and are each referred to herein as narrow (exterior) intermediate side surfaces, as opposed to the broad (exterior) surfaces, being the front surface 320 and the rear surface 330 of the sash 310.

FIG. 3B illustrates a view of an intermediate side of a window sash 310. As shown, the west facing intermediate side 326 of the generic sash 310, like other intermediate sides of the sash 310, has a long dimension 342 and a short dimension 344. With respect to the intermediate side 326, the long dimension is 24 inches in distance (tall), and the short dimension is 1.5 inches in distance (width), as shown. The same dimensions apply to the opposite east facing intermediate side 328 of the generic sash 310.

The depth dimension of the sash 310 is equal to a distance between the exterior front surface 320 and the exterior rear surface 330 surface of each rail of the sash 310. This generic sash 310 is made from rails having a uniform (equal) depth dimension, being equal to the short dimension 344 of each exterior intermediate side 322-328 of the sash 310, and equal to 1.5 inches.

Likewise, the short dimension of an intermediate side surface of a sash rail, the intermediate side facing in a north, south, east or west direction, and facing 90 degrees away from the front surface 320 and the rear surface 330 of the sash 310, is equal to and referred to as the depth dimension 344 of the sash 310, and is equal to 1.5 inches.

The window sash 310 also includes one or more components that are employed to better incorporate the sash 310 into a larger window and its window frame, like the window 210 shown in FIG. 2. As one example shown here, a first end of a pivot bar 340a protrudes from a lower land hand side exterior surface 326 of the sash 310, and a second end of a pivot bar 340b protrudes from a lower right hand side exterior surface 328 of the sash 310. This pivot bar 340a-340b which is also referred to herein as a sash pivot (See FIG. 2), is designed to enable the sash 310 to engage and slide along an interior surface, also referred to herein as a jamb or jamb liner (See FIG. 2), of a window frame 220, like that shown in FIG. 2.

FIGS. 4A-4F illustrate embodiments of sealing pads that are employed for reducing infiltration of matter and energy at locations along a perimeter of different embodiments of a top (upper) sash of a window.

FIG. 4A illustrates a close up view of a pivot bar 340a protruding from a window sash 310a, being a top (upper) sash 310a of the window 210. As shown, the pivot bar 340a protrudes from the lower left hand (intermediate) side 326 of the sash 310a. Notice that there is pre-installed weather stripping 422a, that is white in color and that visually blends in with the white color of the west facing intermediate surface 326 of the left hand side rail of the sash 310a. As shown here, this pre-installed weather stripping 422a is disposed proximate to an upper perimeter of the intermediate exterior surface 326 of the left hand side rail of the sash 310a. This upper side perimeter (corner edge) separating the intermediate exterior surface 326 of the left hand side rail from the front surface 320 of the sash 310a.

The lower left hand corner of the sash 310a, like other corners of the sash 310a, is a location (volume in space) where infiltration of matter and energy can occur through the window 210. Such matter including air, dust, other particulates and/or water, for example. Such energy including heat, light and/or sound, for example. As shown here, this location of infiltration, is referring to an area along the outside perimeter surface of the sash 310a, that is proximate to, abutting, and/or surrounding the pivot bar 340a and/or proximate to the lower left hand side corner of the sash 310a.

FIG. 4B illustrates a close up view of a first embodiment of a sealing pad 410a as it is attached to a sash surface area (area of infiltration) that is proximate to, and adjacent to the lower left hand corner of the first embodiment of the top window sash 310a of FIG. 4A. As shown, the sealing pad 410a is dimensioned (cut, contoured, shaped and sized) and adhered to an intermediate side surface 326 of the left hand side rail of the sash 310a, and is confined to be within the boundaries of this surface 326 that bound the short dimension of this surface 326 of the sash 310a. However, in this circumstance, the sealing pad 410a is further confined to adhere to an exposed portion of the surface 326, other than an unexposed portion of the surface 326 that is currently being occupied by the weather stripping 422a.

The short dimension of this rail side surface 326 being measured parallel to the Z axis 190, and the length (long) dimension of this surface 326 being measured parallel to the Y 180 axis, as shown here. For this embodiment of the sash 310a, the short dimension of this side surface 326 is approximately 1.5 inches in distance, and the length (long) dimension of this side surface, is approximately 24 inches in distance.

Accordingly, the (long) perimeter boundaries that bound the short dimension of this intermediate side surface 326, being parallel to the Y axis, are approximately 1.5 inches apart from each other. The (short) perimeter boundaries that bound the length (long) dimension of this rail intermediate side surface 326, being parallel to the X axis, are approximately 24 inches apart from each other.

However, in this circumstance, the entire surface 326 is not exposed and as a result, the entire surface is not available to be adhered to across its entire short dimension by the sealing pad 410a, because of the presence of the pre-installed weather stripping 422a. As a result, the sealing pad 410a is designed (configured) to be attachable (adhered) and dimensioned in order to attach to the exposed surface that is located (available) between the pre-installed weather stripping 422a and the opposite boundary of this intermediate side surface 326, being the long perimeter side boundary separating this intermediate side surface 326, from the rear (downward facing) side 330 of the sash 310a, from this viewing perspective. The pre-installed weather stripping 422a being located along and proximate to the upper boundary of this intermediate side surface 326, being the long perimeter side boundary separating this intermediate side surface 326 from the front (upward facing) surface 320 of the sash 310a, from this viewing perspective.

This sealing pad 410a includes an opening 412a, through which the pivot bar 340a passes through, while the sealing pad 410a is attached (adhered) to the sash 310a. This opening 412a is dimensioned to be approximately 0.63 inches in distance along the Z axis 190, and approximately the same distance (0.63 inches) along the Y axis 180.

The sealing pad 410a is planar in shape, and is dimensioned (cut, contoured, shaped and sized) to span along (parallel) to the Z axis 190 for a distance of approximately 0.98 inches, and further dimensioned to span along (parallel) to the Y axis 180 for a distance of approximately 1.38 inches. This sealing pad 410a has a thickness dimension that is measured parallel to the X axis and that is equal to approximately 215/1000 inches. In other words, the sealing pad 410a extends (protrudes) approximately 215/1000 inches away from the surface 326 of the sash 310a.

The dimensions of the sealing pad 410a enables it to span 0.98 inches/1.5 inches=0.653, being more than 65% of the distance across the short dimension (depth) of this intermediate side surface 326, and being more than half of the short dimension of this intermediate side surface 326 of the sash 310a. This sealing pad 410a spans the depth of this sash surface 326 by a minimum distance that is at least 60 percent of the short dimension (depth dimension) of this sash surface 326.

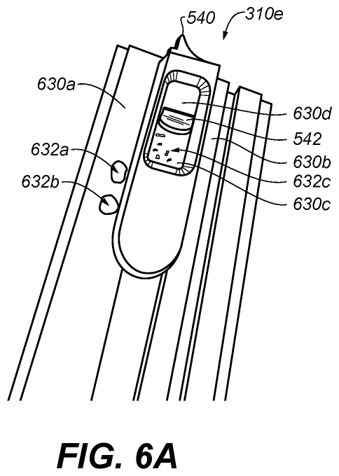

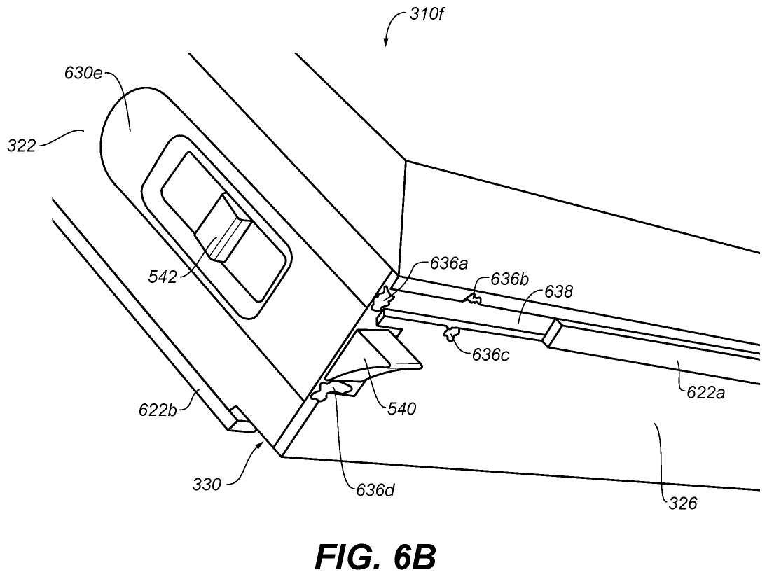

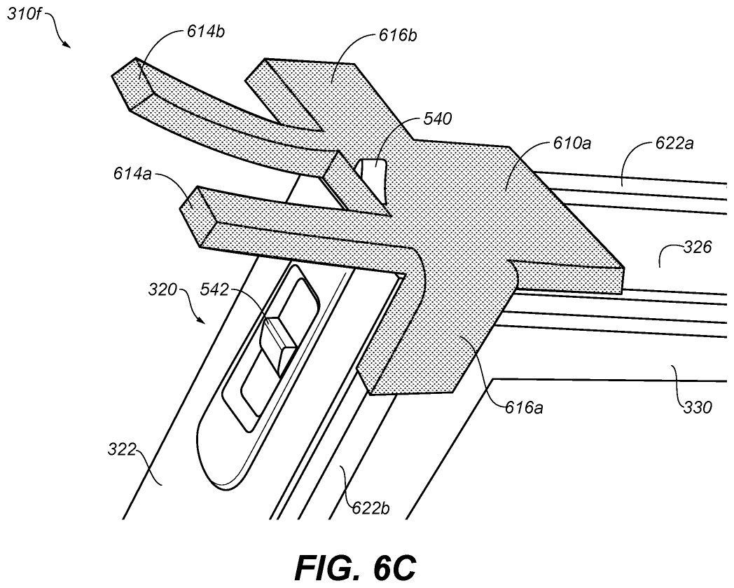

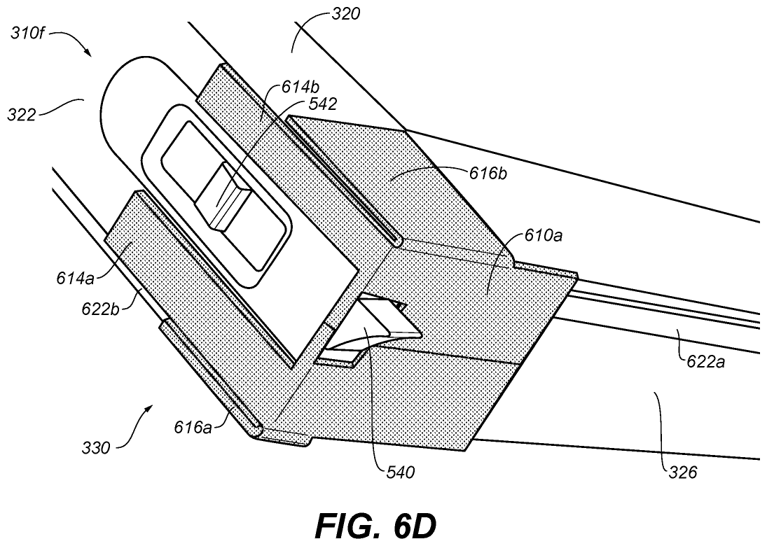

Conversely, the pre-installed weather stripping 422a, being a traditional long and narrow type of weather stripping, appears to span no more than approximately 0.30 inches across the short dimension of this surface 326, being a distance that is substantially less than half of the short dimension of this surface 326 of the sash 310a. Further, the pre-installed weather stripping 422a has a mechanical attachment to the surface 326 via a t-slot connection (See FIG. 6B), and has filaments that bloom (extend) out and away from its mechanical attachment to the surface 326. As a result, the pre-installed weather stripping actually has a smaller footprint and makes less physical contact with the surface 326, and consequently spans a smaller distance along the surface 326 with respect to a direction that is parallel to the short dimension of the surface 326, being parallel to the Z axis, than the distance that its filaments appear to span within the photo of this figure.

Consequently, the additional width (Z axis) dimension of the sealing pad 410a as it is attached to surface 326 functions to provide a longer path of obstruction (resistance) to infiltration of matter and energy, along an expected path of infiltration of the matter and/or energy into and through this window 210, than that provided by the pre-installed and traditional weather stripping 422a. This expected path of infiltration being directed parallel to the short dimension of this surface 326.

The sealing pad 410a has a two dimensional profile that is parallel to the surface 326, which is referred to herein as an adhesion (attachment) surface profile or as a base profile. This base profile is essentially a measure of the area occupied by the footprint of the sealing pad 410a, and this area is approximately 0.98 inches multiplied by 1.38 inches equaling approximately 1.35 square inches. For simplicity, this computation here does not factor the area occupied by the opening 412a. More accurately, when factoring the lack of adhesion surface within the opening, where the opening has an area 0.63 inches×0.63 inches=0.3969 square inches. The net adhesion surface profile is equal to 1.35 square inches minus 0.3969 square inches, equaling 0.9531 square inches. This attachment surface profile is a measure of the amount of attachment (adhesion) that the sealing pad 410a as a whole, has to the surface 326 of the sash.

With respect to adhesion, in some embodiments, a layer of adhesive is applied along the exposed surface of the backing layer. A layer of liner material, which is also referred to herein as a liner layer, or as an offset liner or as a liner, is typically made from a polymer material, and is disposed on an opposite side of the layer of adhesive, relative to the backing layer. Essentially, the layer of adhesive (adhesive layer) is sandwiched in between the backing layer and the liner layer.

Prior to adhering the sealing pad 410a to a surface of an object, such as to a surface of a sash, the liner layer is pulled (peeled/removed) away from the layer of adhesive layer to expose the layer of adhesive, as it is disposed upon the backing layer. The layer of adhesive is then pressed against a surface, such as pressed against a surface of a sash, to adhere the sealing pad 410a onto that surface of the sash. To facilitate removal of the liner layer, the liner layer is preferably dimensioned to extend beyond a perimeter of the sealing pad 410a so that an edge of the liner layer protrudes away from the sealing pad and can be easily pinched and pulled away from the sealing pad 410a, while employing as few as two fingers of one hand.

In some other embodiments, the sealing pad 410a is instead adhered to a window sash via application of pressure sensitive adhesive. The pressure sensitive adhesive is known as a High Tack Pressure Sensitive Adhesive 3794, which is supplied by the 3M Corporation. This adhesive can be spray or bead applied to a surface, such as to the exposed backing surface and/or to a surface of an object, such as to a surface of a sash, and can be applied via bulk application equipment. No liner layer is required when adhesive is applied in this manner. This adhesive can also be applied for other applications, for example, for bonding of plastics, paper materials and die cut labels. Other adhesives, capable of bonding a polymer material to a material of the window, such as wood, aluminum, fiberglass or vinyl, can also be employed.

With respect to the dimensions of a sealing pad, the sealing pad 410a has a shape that is far less long and narrow, and provides a much wider (broader) surface contact footprint, than traditional weather stripping. It provides a more equal balance of its dimensions, being the length (Y axis) in relation to its width (Z axis), than the traditional weather stripping. For example, the pre-installed weather stripping 422a, has a length of approximately 24 inches and a width of about 0.30 inches, and the ratio of its length to its width equals 24/0.30=80.0. Conversely, the sealing pad 410a has a length of approximately 1.38 inches and a width of about 0.98 inches, and the ratio of its length to its width equals approximately 1.38/0.98=1.41. Unlike traditional weather stripping, the sealing pad 410a could be dimensioned to span and adhere to the entire length and the entire depth of a rail surface of the sash 310a.

The wider dimension of the sealing pad 410a, as compared to traditional weather stripping, and in relation to the pre-installed weather stripping 422a, provides a wider amount, and a longer path, of physical obstruction and resistance to a flow of matter and energy occurring in a direction parallel to the Z axis, between the perimeter of the sash 310a and the frame of the window 210. The wider dimension of the sealing pad 410a also provides a wider surface of adhesion for the sealing pad 410a to attach to a surface of the sash 310a.

The sealing pad 410a is also dimensioned and attached (disposed) at a location along the sash 310a, so that the sealing pad 410a has a low visual profile from a viewing perspective of someone operating and/or viewing the window 210. The viewing perspective being from a location that is inside of a wall of a building structure within which the window 210 is installed. In other words, the sealing pad 410a is designed to improve the functioning of the window 210 without significantly affecting the appearance of the window.

FIG. 4C illustrates a close up view of a second embodiment of a sealing pad 410b prior to the sealing pad 410b being attached to a sash surface area that is proximate to, including and surrounding the lower left hand corner of a second embodiment of a window sash 310b, being a top window sash 310b of the window 210. This second embodiment 310b of the sash 310b includes two pre-installed lines of weather stripping 424a-424b of a dark grayish color, spanning along the intermediate side 326 of the left rail of the sash 310b.

As shown, the sealing pad 410b is dimensioned (cut, contoured, shaped and sized) to surround the pivot bar 340a, and to surround (straddle) the lower left hand corner of a (top) window sash 310b of the window 210, when the sealing pad 410b is attached to at least a portion of both the west facing intermediate side surface 326 of the left rail of the sash 310b, and attached to at least a portion of the south facing intermediate side surface 324 of the bottom rail of the (top) window sash 310b of the window 210.

Like the sealing pad 410a, the sealing pad 410b is dimensioned (cut, contoured, shaped and sized) to substantially span a short (sash depth) dimension of a portion of the west facing intermediate side surface 326, and to substantially span a short dimension (sash depth) of a portion of the south facing intermediate side surface 324, of the window sash 310b. Furthermore, like the sealing pad 410a of FIG. 4B, the sealing pad 410b of this figure includes an opening 412b, through which the pivot bar 340a passes through, when the sealing pad 410b is attached (adhered) to the sash 310b.

Also, the sealing pad 410b is further dimensioned to include a side protruding appendage portion 418, also referred to herein as a side flap 418, which is designed to attach to a front surface 320 of the bottom rail of the sash 310b, at a location that is proximate to and/or abutting (touching) a meeting rail 420. As shown, the meeting rail 420 is located along a lower portion of the front surface 320 of the bottom rail of the (top) window sash 310b.

For this embodiment of the sash 310b, unlike the sash 310a of FIGS. 4A-4B, the west facing surface of the intermediate side 326 of the left-hand rail, is bounded by a two lines of pre-installed weather stripping 424a-424b, that are each dark and gray in color, and that are each disposed along a one of two long (length) perimeter edges of this side surface 326 of the window sash 310b.

This arrangement (design) of pre-installed weather stripping, creates a narrowed corridor along the intermediate side surface 326 of the left rail of the sash 310b, where this narrowed corridor resides in between the two lines of pre-installed weather stripping 424a-424b. The pivot bar 340a resides within this narrowed corridor and at a location that is proximate to a lower bottom end of this intermediate side surface 326 and proximate to a terminal end (entrance/exit) of this narrowed corridor.

This narrowed corridor, which is also referred to herein as a corridor, can cause a wind tunnel (chimney) effect when a flow of outside air finds its way into this corridor, which can act as a passageway for such a flow of air. Such an effect can cause the flow of air to escape the confines of this corridor, where the escape is likely directed through a terminal end of this corridor, acting as an air flow exit to this corridor. If the flow of air exits this corridor, the air could pass into an interior building (living) space adjacent to the window. This effect can also be caused and/or exacerbated as a result of bowing of a window frame within which a sash 310b is installed.

In response to the presence of this narrowed corridor, the design of this particular sealing pad 410b is dimensioned (cut, contoured, shaped and sized) to fit into and adhere to this intermediate side surface 326 that is disposed in between these two lines of weather stripping 424a-424b and within this narrowed corridor. As adhered (installed) at this location on the sash surface 326, the sealing pad 410b obstructs (resists) passage of air and other matter through (into or out of) this end (entrance/exit) of this narrowed corridor, and effectively plugs (obstructs) this end of this narrowed corridor.

FIG. 4D illustrates a close up view of an embodiment of sealing pad 410b of FIG. 4C, as it is attached in an area that is proximate to, including and surrounding to a lower left hand corner of the embodiment of the top window sash 310b of the window 210.

As shown, the sealing pad 410b is dimensioned (contoured, cut, shaped and sized) and located to surround the pivot bar 340a, and to surround (straddle) the lower left hand (south west) corner of the (top) window sash 310b of the window 210, and to cover at least a portion of the front side 320 of the lower left hand rail of the window sash 310b, as the sealing pad 410b is attached to a portion of both the west facing surface 326 of the lower left hand rail and attached to a portion of the south facing surface 324 of the bottom rail, and attached to a portion of the front surface 320 of the bottom rail, of this embodiment of the top window sash 310b of the window 210.

Also, the sealing pad 410b is dimensioned (contoured, cut, shaped and sized) to substantially span a short dimension (sash depth) of at least a portion of the west facing surface of left hand intermediate side 326 and to substantially span a short dimension (sash depth) of at least a portion of the south facing surface of the intermediate side 324 of the bottom rail of the sash 310b. Furthermore, like the sealing pad 410b of FIG. 4B, the sealing pad 410b of this figure includes an opening 412b, through which the pivot bar 340a passes through, as the sealing pad 410b is attached (adhered) to the sash 310b.

The sealing pad 410b is dimensioned and disposed at a location so that the sealing pad 410b has a low visual profile from a viewing perspective of someone viewing and/or operating the window 210, from the inside of a building structure within which the window 210 is installed. In other words, the sealing pad 410b is designed to improve the functioning of the installed window 210 without significantly affecting the appearance of the installed window 210.

As shown in FIG. 4F, this sealing pad 410b has a long dimension (length) equal to approximately (3) three inches. Of this long dimension, approximately (1) one inch of this long dimension is designed (intended) to be adhered along the west facing intermediate sash surface 326 and the approximately remaining (2) inches of this long dimension is designed (intended) to be adhered along the south facing intermediate sash surface 324.

In a variation of this embodiment, an alternatively dimensioned and elongated sealing pad, having the features of the sealing pad 410b, is instead dimensioned to span an entire long dimension (length) of the south facing intermediate surface 324 of the bottom rail of the sash 310b, and to further extend along the east facing intermediate surface 328 of right hand side rail of the sash 310b, to also surround the pivot bar protruding from that east facing sash surface 328.

This alternatively dimensioned (elongated) sealing pad would be one contiguous sealing pad having a long dimension equal to at least 26 inches, given that the long dimension of this elongated sealing pad would entirely span the long dimension (24 inches) of the south facing surface 324 and would further extend at least one more inch along the west facing surface 326 and at least one more inch along the east facing surface 328, in order to at least surround a pivot bar protruding along each of these sash intermediate side surfaces 326-328 of a sash. Optionally, this elongated sealing pad to extend father along the west facing 326 and east facing 328 surfaces.

Given that there is no pre-existing weather stripping installed along the south facing surface 324 of this sash 310b, this sealing pad 410b, and/or the elongated sealing pad, could instead be further dimensioned to span farther across and/or to span entirely across the short (depth) dimension, of the south facing surface 324. The short dimension of the south facing surface 324 being a distance of 1.5 inches.

Given that the south facing surface 324 is pressed against a lower surface of the frame of the window 210, when the sash 310b is fully installed into the window 210, this elongated sealing pad to would also provide a low visual profile, like the sealing pad 410b.

FIG. 4E illustrates an alternate perspective view of the embodiment of sealing pad 410b of FIGS. 4C and 4D, after the sealing pad 410b has been attached to the window sash 310b of FIGS. 4C-4D.

As shown, the side flap 418, being the side protruding appendage portion 418 of the sealing pad 410b, is visible to the viewer of this figure as it is attached to the front facing surface 320 of the bottom rail of the top sash 310b, while the sash 310b is installed into the window 210. The side flap 418 is attached proximate to the meeting rail 420, of the sash 310b.

As shown here, notice that the bottom sash is not fully installed into the window 210, and is instead, tilted partially away from the window 210. Alternatively, when the bottom sash is fully installed into the window 210, then the top rail of the bottom sash would press against the bottom rail of the top sash 310b, and cause the side flap 418 to be visually obstructed from view by the top rail of the bottom sash.

During manufacturing of a window like the window 210, the two extreme end portions of the meeting rail 420 are cut away to provide better access to the lower corners of the top sash 310b, upon which the meeting rail is attached, and for the purpose of the completing the welding and cutting (routing) actions that are necessary to complete manufacturing of the window. At the locations of these two end portions along the meeting rail 420, the absence of these portions of the meeting rail 420 can create an air gap that is vulnerable to infiltration of air particulates and possibly moisture, passing in an upward direction and in between the lower sash and the upper sash at these locations where the meeting rail once was, and where the meeting rail 420 is absent upon completion of the manufacturing of the window.

As attached to front surface 320, the flap portion 418 of the sealing pad 410b effectively plugs this air gap between the upper and lower sashes within the window 210. Other portions of the sealing pad 410b, which are attached to two other planes, being the west facing intermediate side surface 326 of the left hand rail, and further being the south facing intermediate side surface 324 of the bottom rail, of the upper sash 310b, provide additional obstruction against infiltration of air flow and provide additional surface area of adhesion and anchoring of the sealing pad 410b, as a whole, to better support the adhesion of the side flap 418 onto the front surface 320 of the upper sash 310b.

FIG. 4F is an illustration of the sealing pad 410b of FIGS. 4C-4E, prior to installation of the sealing pad within the window 210. As shown, this sealing pad 410b is lying horizontally flat while the exterior (adhesive) surface of the backing (lower) layer of the sealing pad 410b is facing the viewer. The sealing pad 410b is dimensioned (cut, contoured, sized and shaped) to adapt to the particular dimensions of the window 210.

As shown, the sealing pad 410b includes the opening 412b and the protruding appendage (side flap) 418. A folding line 416 is indicated by a dashed line. The folding line 416 indicates where the sealing pad 410b is expected to fold over a corner of the sash 310b, when it is installed onto the sash 310b. The sealing pad 410b is overall, asymmetrical in shape. The length of edges of the sealing pad 410b are indicated in units of one-hundredths of an inch.

This particular embodiment of the sealing pad 410b is dimensioned to reflect the dimensions of the top sash 310b of the window 210. In other embodiments, differently dimensioned sealing pads are designed and manufactured to adapt to the particular dimensions of the designs of sashes, other than the sashes 310a-310b, and/or for the designs of windows, other than the window 210. A portion of the sealing pad 410b spanning the north facing upper (top) sash surface 324 has a width dimension equal 1.25 inches. This sealing pad 410b, spans the short dimension (depth) of this sash surface 324, being equal to a distance of 1.5 inches, by a minimum distance that is at least 70 percent, and also by a minimum distance that is at least eighty percent, of the short dimension (depth dimension) of this sash surface 324.

The sealing pads are preferably cut via a robotic controlled laser. In one manufacturing embodiment, rough stock of sealing pad material is produced in 2.25 inch wide strips that are each cut into a plurality of sealing pads that each possess particular sealing pad dimensions to adapt (fit into) a particular sash and/or window design. In other embodiments, the rough stock of sealing pad material is produced in strips that are wider or narrower than 2.25 inches.

An advantage of employing a laser, as opposed to a mechanical cutter, such as a die cutting device, is that far more filaments are typically detached (lost) from the backing surface of weather stripping when employing a die cutting device to cut the weather stripping. This loss of filaments is also referred to as the shedding of filaments while cutting. Such shedding requires that the loose filaments be cleaned away from the weather stripping, requiring extra work relative to an alternative of employing of a robotic laser to cut such weather stripping. Also, a robotic controlled laser can be programmed to cut a wide variety of differently dimensioned sealing pad designs, in various quantities, and on demand.

In some embodiments, a robotic laser is employed to cut rough (raw) stock of sealing pad material from a roll of such sealing pad material. The raw stock is produced in a shape of a long strip of sealing pad material. The robotic laser cuts along a perimeter path of a particular design of a sealing pad, and cuts almost an entire length of the perimeter path of that particular sealing pad design. For example, a section of a roll of two inch wide rough stock of sealing pad material, can be cut to form the sealing pad 410b of FIG. 4F. In this embodiment, a long dimension of the sealing pad 410b, being two inches in length, is oriented in a direction that is parallel to the length (long dimension) of the strip of sealing pad material which is configured into a roll of such sealing pad material.

The entire perimeter of the sealing pad 410b is not cut from the strip of sealing pad material. Instead, and in this embodiment, almost the entire perimeter, except for a one half inch portion of the perimeter of the sealing pad 410b, is cut from the roll. In this embodiment, this one half inch portion that remains uncut, is centered along the lowest perimeter edge of the sealing pad 410b, as it is shown in FIG. 4F. This uncut portion is also referred to herein as a sealing pad attachment tag, or as an attachment tag, or as a tag. Preferably, this tag is at least one sixteenth of an inch in length.

Each almost entirely cut sealing pad 410b resides within the roll of sealing pad material, and is separated from each other along the long dimension of the roll of sealing pad material by one quarter of an inch. As a result, a 40 foot roll of sealing pad material can store approximately 215 almost entirely cut sealing pads 410b. When storing almost entirely cut sealing pads, such a roll of sealing pad material is effectively a roll of sealing pads.

This roll of sealing pads can be shipped to a purchaser, being a product manufacturer, for example. Personnel of the product manufacturer can mount the roll of sealing pads onto a spool, and then separate a sealing pad 410b from the roll of sealing pads by simply cutting the remaining one half inch of the uncut perimeter of a sealing pad 410b from the roll of sealing pads. This cutting can be performed with a pair of scissors or some other cutting instrument, for example. The sealing pad 410b, being separated from the roll of sealing pads, is now available for receiving an application of an adhesive to facilitate installation of the separated sealing pad 410b onto a product of the product manufacturer.

In some embodiments, this strip of sealing pad material includes an adhesive layer and a liner layer, in addition to the backing layer and the filament pile layer. To facilitate removal of the liner layer, the liner layer is preferably dimensioned to extend beyond a perimeter of the strip including each sealing pad so that an edge of the liner layer can be easily pinched and pulled away from the sealing pad 410a, while employing as few as two fingers of one hand. The liner layer preferably extends by at least one half of an inch beyond the perimeter of the strip, where the perimeter of the strip is a perimeter boundary that is parallel to a long dimension (length) of the strip of sealing pad material.

This manufacturing technique enables a large quantity of manufactured sealing pads to be efficiently packaged into a roll of sealing pads, for storage and/or shipping, prior to installation of each sealing pad onto an object, being a manufactured object, such as a window sash for example. An unused (un-installed) portion of the roll of sealing pads, can remain on a spool until it is next required for use, or else the roll of sealing pads can be removed from the spool and stored into inventory, until it is next required for use.

At various locations along the perimeter of the sash 310a-310b, in addition to the corners of the sash, there can also be vulnerability to infiltration of matter including air, dust, other particulates and/or water. Such infiltration can occur along the intermediate sides of the sash 310, and at locations between the corners of the sash 310, as it is installed into the window 210.

Performing an infiltration test upon a particular manufactured window can identify locations of vulnerability for infiltration within that particular window. Such locations are unique and specific to that particular window, and are identified portions (locations) within the window as allowing passage of an excessive amount of air during the infiltration test. The passage of air at a particular location within the window creates a vulnerability of the window to also pass dust, dirt and other particulates and/or water that can be carried by the passage of air during future use of the window.

However, testing two manufactured windows having a same design and being manufactured by a same manufacturer, can and often possess different specific locations of vulnerability that are identified during the infiltration test. In other words, manufactured windows are not necessarily identical to each other, even if such windows are in theory, intended to be identical to each other.

To respond to this type of vulnerability, and in accordance with the invention, sealing pads 410 of various dimensions can be designed and manufactured (dimensioned) (cut, contoured, shaped and sized) to better seal along the perimeter of both the top and bottom sashes 310 of the window 210, and along the perimeter of sashes of various other designed and/or manufactured windows, at locations at, near or away from the corners of the sash 310.

Also for example, not all window sashes include a pivot bar and a tilt latch, and if for a particular window design, there exists no pivot bar or tilt latch, then the sealing pads 410 are designed to not include an opening to accommodate a pivot bar or tilt latch, and instead, an alternatively designed sealing pad, that does not include any opening, would be dimensioned and attached at locations along the perimeter of the sash 310, at such locations including the lower left hand and right hand corners of the sash 310, and/or other corners of the sash 310, and at locations between and away from the corners of the sash 310.

In some embodiments, a method of the invention is provided for reducing infiltration of matter and/or energy through a window, the method including the steps of, acquiring a manufactured window, performing an infiltration test to detect infiltration of at least some matter and/or energy through said window; and identifying (detecting) one or more locations within the window, such as along a surface of a window sash as it is installed within the window, where infiltration of the matter and/or energy is occurring during the infiltration test, and as determined in accordance with results the infiltration test; and attaching at least one sealing pad at a location of one of at least the one or more locations within the window, such as at a location along a surface of said window sash, in order to reduce infiltration of the matter and/or energy occurring at those one or more location(s) (targeted locations) within the manufactured window.

Note that optionally, the infiltration test might be focused upon a limited set of tests, and may for example, focus on the infiltration of air, but not of light or sound, for example. The one or more locations where infiltration of energy and/or matter is being detected to occur, become (priority) targets, or targeted locations, where applying (attaching) sealing pads can substantially reduce the overall infiltration of matter and/or energy through the window. Priority should be directed to those locations that are detected to have a maximum amount of infiltration of matter and/or energy in accordance with the results of the infiltration test.

The above method is an alternative to re-designing and/or re-manufacturing the previously (already) manufactured window, and as a result, is a value added method of upgrading a manufactured window to a higher standard of resistance to infiltration of matter and/or energy. Such a higher resistance to infiltration to infiltration of matter and/or energy reducing the amount of infiltration of matter and/or energy passing through the window during future use of the window.

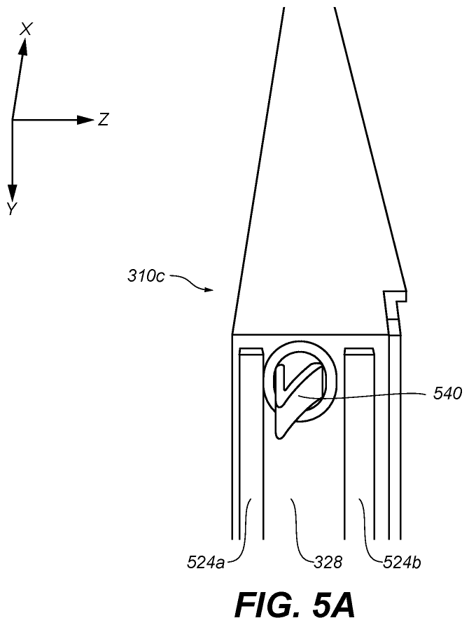

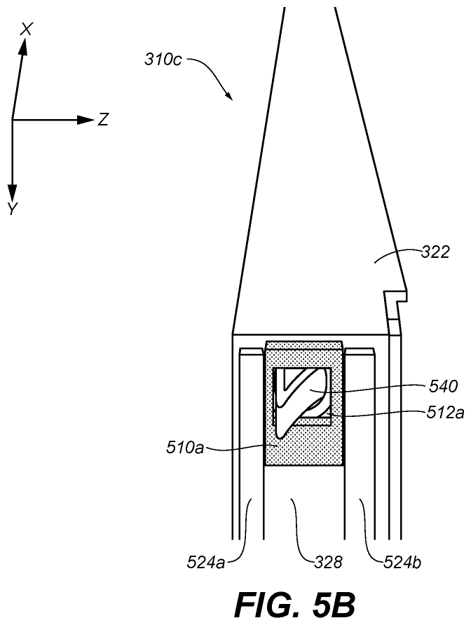

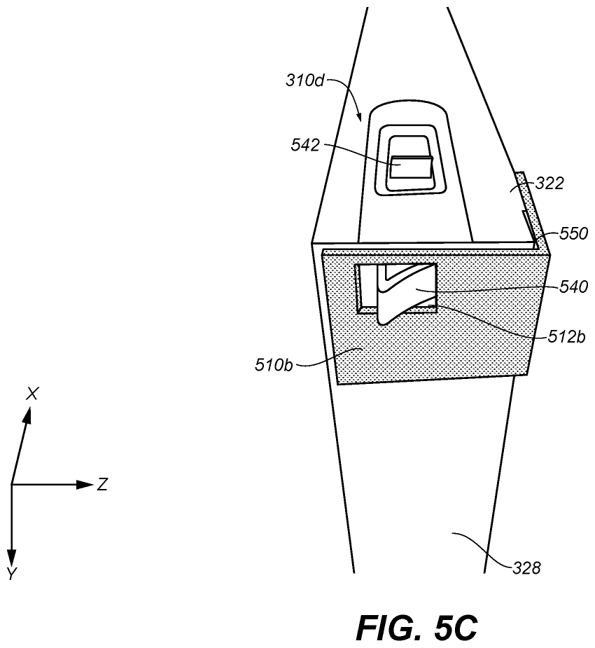

FIGS. 5A-5C illustrate embodiments of sealing pads that are employed for reducing infiltration of matter and energy at locations along a perimeter of different embodiments of a bottom (lower) sash of a window.

FIG. 5A illustrates a close up view of a right hand side tilt latch 540 of a third embodiment of a window sash 310c of the window 210, being a bottom type of window sash with pre-installed weather stripping. As shown, the tilt latch 540 protrudes from the upper right hand (east facing) side 328 of the sash 310c. The upper right hand (northeast) corner of the sash 310c, like other corners of the sash 310c, is a location (of area of infiltration) where infiltration of matter, such as including air, particulates and/or water can occur. Such infiltration can also occur around the tilt latch 540 itself, wherever it may be located, and which is now as shown, being located proximate to the upper right hand corner of the sash 310c.

FIG. 5B illustrates a close up view of an embodiment of sealing pad 510a as it is attached in an area (area of infiltration) that is both proximate and adjacent to the upper right hand corner of the third embodiment of the bottom window sash 310c of FIG. 5A. As shown, the sealing pad 510a is dimensioned (cut, contoured, shaped and sized) and adhered to a surface area that substantially spans a short dimension (sash depth) along at least a portion of the east facing surface of the right hand (intermediate) side surface 328 of the sash 310c.

The short dimension of an intermediate sash side surface, which is also referred to as the sash depth or side surface width of the intermediate sash side surface, being directed parallel to the Z axis 190 of the sash 310c. As shown here, the depth dimension of the sash 310c being measured parallel to the Z axis 190. Furthermore, the sealing pad 510a includes an opening 512a, through which the tilt latch 540 passes through, while the sealing pad 510a is attached (adhered) to the sash 310c.

The sealing pad 510a is dimensioned and attached at a location so that the sealing pad 510a has a low visual profile from a viewing perspective of someone operating and/or viewing the window 210. The window 210 often being viewed from a location that is inside of a wall of a building structure within which the window 210 is installed. In other words, the sealing pad 510a is designed to improve the functioning of the sash 310c as it is installed within the window 210, and as the window is installed within a wall, while without significantly affecting the appearance of the sash 310c and the window 210.

For this particular embodiment of the sash 310c, the east facing surface, being the intermediate side 328 of the right hand rail of the sash 310c, is bounded by a two lines of pre-installed weather stripping 524a-524b. Each line of pre-installed weather stripping is disposed proximate and parallel to one of two perimeter edges of this intermediate side 328 of the right hand side rail of the window sash 310c.

This particular sash design creates a narrowed corridor along the outer surface area of the left hand intermediate side 328 of the sash 310c, the narrowed corridor being located in between the two lines of weather stripping 524a-524b. This narrowed corridor, also referred to herein as a corridor, is vulnerable to a flow of outside air into the interior building (living) space surrounding the window, as discussed in association with FIG. 4C.

Like described in association with FIG. 4C, if a flow of outside air enters this corridor and exits upwards along the east facing 328 or west facing 326 intermediate side of a bottom sash 310c, then that flow of air would exit along the top rail of the bottom sash and enter the interior building (living) space surrounding the window.

In this circumstance, it would beneficial to seal (plug) this corridor with at least one sealing pad, such as sealing pad 510a, to obstruct and/or prevent the flow of air from passing through and exiting this corridor, and obstruct and/or prevent such a flow of air from passing through this window 210 and into interior building (living) space adjacent to the window 210. A similar scenario could occur with the top window sash where such a flow of outside air could exit the window 210 along the top rail of the top window sash.

The tilt latch 540 resides within the corridor and at a location that is proximate to a terminal end, being an entrance/exit of this corridor. In response to the presence of this narrowed corridor, the design of this particular sealing pad 510a is dimensioned (cut, contoured, shaped and sized) to fit onto and adhere to at least a portion of the intermediate side surface 328 of the left hand rail of the sash 310c that resides within this narrowed corridor. As shown, the sealing pad 510a effectively obstructs against the flow of air upward and outward from this corridor.

FIG. 5C illustrates a close up view of a right hand side tilt latch 540 of a fourth embodiment of a window sash 310d of the window 210. This fourth embodiment of the window sash 310d being a bottom window sash without pre-installed weather stripping along the left hand and right hand sides of the window sash 310d. Unlike the second and third embodiments of the sash 310b-310c, shown in FIGS. 4C-4F and FIGS. 5A-5B respectively, the fourth embodiment of the window sash 310d lacks the pre-installed lines of weather stripping 522a-522b.

As shown, a sealing pad 510b is designed to surround the tilt latch 540 and to attach to both the east facing intermediate side surface 328 of the right hand side rail surrounding the tilt latch 540, and to also attach to the rear facing side surface 330 of the top rail of the bottom sash 310d, that is located proximate to the tilt latch 540.

As shown, the tilt latch 540 protrudes from the upper right hand side 328 of the sash 310d. Another tilt latch protrudes from the upper left hand side 326 of the sash 310d (not shown here). The upper right hand corner of the sash 310d, and the upper left hand corner of the sash 310d, like other corners of the sash 310d, are locations (areas of infiltration) where infiltration of matter, such as including air, particulates and/or water can occur. Such infiltration can also occur around the tilt latch 540 itself, which is located proximate to the upper right hand corner (as shown here) and proximate to the upper left hand corner (not shown here) of the sash 310d.

This fourth embodiment of a window sash 310d, being a bottom type of window sash 310d, also includes a tilt latch control mechanism 542, which is designed to unlock the tilt latch 540, prior to tilting the sash 310d away from its installed position within the window 210.

As shown, the sealing pad 510b is dimensioned to surround both the tilt latch 540 and to further wrap around a (rear northeast) corner 550 of the window sash 310d that separates the east facing intermediate side surface 328 of the sash 310d, from the rear side surface 330 of the sash 310d. When installed into the window 210, the rear side 330 attached portion of the sealing pad 510b is disposed at a location that is proximate to a terminal end of a meeting rail (not shown here) of a top sash, when that top sash is also installed within the window 210 along with this bottom sash 310d. The location of this sealing pad 510b is proximate to a location of the sealing pad 412b and its side flap 418, as shown in FIG. 4E.

The short dimension if this sash surface 328 is equal to 1.5 inches. As shown visually, this sealing pad 510b, spans the short dimension (depth) of this sash surface 328 by 1.38 inches, being a minimum distance of at least 90 percent, of the length (1.5 inches) of the short dimension (depth dimension) of this sash surface 328.

FIGS. 6A-6D illustrate characteristics of a sash surface and an embodiment of a sealing pad 610a that is employed for reducing infiltration of matter and energy along a sash surface including such characteristics.

FIG. 6A illustrates a close up view of a left hand side tilt latch 540 of a fifth embodiment of a window sash 310e of the window 210, being a top (upper) type of window sash 310e. As shown, a tilt latch 540 protrudes from the upper left hand side 326 of the sash 310e. Also shown is a tilt latch control mechanism 542 that is disposed along a north facing and top (upper) intermediate side surface 322 of the window sash 310e. The tilt latch control mechanism 542 is designed to unlock the tilt latch 540, prior to tilting the sash 310e away from its installed position within the window 210.

Adjacent to the tilt latch control mechanism are recessed areas 630a-630c which enable a one or more pockets of air (air pockets) to be disposed around the tilt latch control mechanism 542, while the sash 310e is installed inside of the window 210. Such pockets of air form along the north facing top intermediate side surface of the sash 310e. These air pockets can collect debris 632, such as dirt and dust 632c, and insects 632a-632b, from infiltration of air flowing into and through the window 210.

Embodiments of a sealing pad can be dimensioned in addition to surrounding the tilt latch 540, to also surround the tilt latch control mechanism 542, and to cover and/or occupy at least some of these recessed areas 630a-630c to prevent insects and other debris 632a-632c from settling into and collecting into these recessed areas 630a-630c.

FIG. 6B illustrates a close up view of a left hand side tilt latch 540 of a sixth embodiment of a window sash 310f of the window 210, being similar to that of window sash 310e. As shown, a tilt latch 540 protrudes from the upper left hand side 326 of the sash 310f. Also shown is a tilt latch control mechanism 542 that is disposed along a top (north facing) intermediate side surface 322 of the sash 310f.

One line of traditional weather stripping 622a (white color), is mechanically pre-installed via a t-slot 638 disposed into the left hand (west facing) intermediate side surface 326 of the sash 310f. Another line of traditional weather stripping 622b (dark color) is pre-installed onto the rear surface 330 of the top rail of the sash 310f. Notice that the weather stripping 622a (white color) has been cut away to accommodate attachment of a sealing pad described in FIG. 6C.

Also, notice that there are a plurality of surface irregularities 636a-636d near the upper left hand side 326 of the sash 310f. There irregularities are typically caused by welding and/or cutting of the sash rails during a process of joining (attaching) the sash rails to each other to form the sash 310f, during the process of manufacturing of the sash 310f and window 210. These sash rails are welded together at locations where the rails are joined together. These locations are referred to herein as joints or sash joints.

Notice that the irregularity 636d is a small opening (orifice/hole) into an interior portion of the sash 310f. Such an opening can also be caused by a screw engaging and penetrating a surface of the sash 310f, forming a screw hole that may create a such a small opening, especially if the screw should become loose or detached from the sash 310f. A flow of air and other matter into this small opening can potentially cause damage inside of the sash 310f, and further cause such air and other matter to exit the interior of the sash 310f at some other location along the surfaces of the sash 310f. To prevent such potential damage, it is important prevent any such penetration and to seal (plug) this type of irregularity (office/hole) 636d.

Many sash rails are made from PVC (polyvinyl chloride) material, which is also referred to herein as vinyl. Welding of this material causes the PVC material to melt and often form an irregular surface as a result of such melting. An example of an irregular surface being a surface that is intended to be shaped in a particular way, for example to be entirely flat, but instead the surface is not entirely flat after welding, because the irregular surface includes unwanted protrusions and/or cavities (holes) and/or wavy portions, formed from the melting and from the re-solidification of the welded and melted PVC material.

To reduce an effect of such irregularities, some irregularities can be cut away from the welded surface (s). After such cutting, what typically remains is an irregular surface, but a surface that is less irregular, than the welded surface prior such cutting. Optionally, an outside corner of one or more of these sash joints, which constitutes a corner of the manufactured sash 310f, is chamfered via such cutting action.

FIG. 6C illustrates a close up view of the tilt latch of the sash 310f of FIG. 6B being surrounded by a partially attached sealing pad 610a. As shown, a sealing pad 610a is designed to surround the tilt latch 540 while being attached to four (4) different sash surfaces. These surfaces are the west facing intermediate side surface 326, the north facing top surface 322, and both of the front 320 and rear 330 surfaces of the sash 310f.

These surfaces 320-322, 326 and 330 are each aligned along geometric planes that are either perpendicular or parallel in relation to each other. For example, surfaces 322 and 326 are perpendicular to each other, and surfaces 320 and 330 are parallel to each other. Also each of the surfaces 320 and 330 are perpendicular to the north facing intermediate side surface 322 and to the west facing intermediate side surface 326. The sealing pad 610a, being one contiguous manufactured object, is designed to attach to these four (4) different surfaces of the sash 310f at one same time when fully installed onto the sash 310f.

Notice that the second line of pre-installed weather stripping 622b (dark color), like the first line of pre-installed weather stripping 622a (white color), a portion of 622b has been cut back to accommodate attachment of the sealing pad 610a. As (partially) attached to the sash 310f in FIG. 6C, the sealing pad 610a, attaches over and effectively encapsulates the irregularities 636a-636d, while obstructing a flow of air and other matter in close proximity to these irregularities 636a-636d, shown in FIG. 6B.

FIG. 6D illustrates a close up view of the tilt latch of FIG. 6B being surrounded by a fully attached sealing pad 610a onto the sash 310f. As shown, a sealing pad 610a is designed to surround the tilt latch 540 while portions (appendages) 614a-614b and 616a-616b of the sealing pad 610a are being attached to four (4) different sash surfaces. These surfaces are the west facing intermediate side surface 326, the north facing top surface 322, and both of the front 320 and rear 330 surfaces of the sash 310f. Being designed to attach to four (4) different surfaces of the sash 310f, which are each oriented parallel to different geometric planes, enables the sealing pad 610a to have a stronger attachment to the sash 310f, while providing more resistance to infiltration of matter and energy through the window 210.

Being that the sash 310f, is a top sash, the portion of the sealing pad 610a, being 614a-614b, which is attached to the north facing (upper) surface 322, provides obstruction to infiltration of air within the proximity of the tilt latch control mechanism 542. This portion of the sealing pad 610a is disposed at a location that is typically adjacent to and pressed against an upper surface of a window frame, when the top sash 310f is disposed at its normal operating positon. When the sash is disposed at this normal operating position, this north facing (upper) surface 322 is not visible from the interior living space surrounding the window 210.

This sealing pad 610a has a width dimension greater than 1.5 inches at a location just below the tilt latch 540. This width dimension spans the entire depth dimension of the sash surface 326, and further at least partially spans the sash front surface 320 and at least partially spans the sash rear surface 330. As a result, this sealing pad 610a spans the short dimension (depth dimension) of this sash surface 326, being equal to a distance of 1.5 inches, and spans by 100 percent, of the short dimension (depth dimension) of this sash surface 324. Spanning the depth of this sash surface 326 by 100 percent, this embodiment of the sealing pas 610a further satisfies spanning this sash surface 326 by a minimum distance of at least 50 percent, by a minimum distance of at least 60, percent, by a minimum distance of at least 70 percent, by a minimum distance of at least 80 percent and by a minimum distance of at least 90 percent. Note that subject matter described in association with an upper sash, can generally also be applied to a lower sash, and vice versa.

This written description uses example embodiments to disclose the invention, to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### PARTS LIST

110 pile of filaments
112a-112c cluster(s) of filaments
114a-114b air gap(s) (corn rows)
120 backing layer
130 second embodiment of weather stripping
132a-132h cluster(s) of filaments
142a-142g air gaps (corn rows)
160 corner of a window sash
162 air gap visible to human eye
170 X axis
180 Y axis
190 Z axis
220 window frame
222a upper sash
222b lower sash
224a jamb liner (left hand side)
224b jamb liner (right hand side)
226a lower perimeter rail portion
226b upper perimeter rail portion
310 window sash
310a first embodiment of window sash
310b second embodiment of window sash
310c third embodiment of window sash
310d fourth embodiment of window sash
310e fifth embodiment of window sash
310f sixth embodiment of window sash
320 front (facing) surface of window sash 310
322 top (intermediate) side surface of window sash 310
324 bottom (intermediate) side surface of window sash 310
326 left hand (intermediate) side surface of window sash 310
328 right hand (intermediate) side surface of window sash 310
330 rear (facing) surface of window sash 320
340a pivot bar protruding from left hand (intermediate) side of window sash 310
340b pivot bar protruding from right hand (intermediate) side of window sash 310
342 long dimension of (intermediate) side surface of window sash 310
344 short dimension of (intermediate) side surface of window sash 310
410a sealing pad of FIG. 4B (surrounding pivot bar)
410b sealing pad of FIGS. 4C-4D
412a opening within sealing pad 410a of FIG. 4B (surrounding pivot bar)
412b opening within sealing pad 410b of FIGS. 4C-4D (surrounding pivot bar)
416 folding line of sealing pad 410b
418 side flap of sealing pad 410b
420 meeting rail portion of sash 310b
422a strip of pre-installed weather stripping (light/white in color)
424a-424b strip(s) of pre-installed weather stripping (dark/grey in color)
510a sealing pad of FIG. 5B (surrounding tilt latch)
510b sealing pad of FIG. 5C (surrounding tilt latch)
512a opening within sealing pad 510a of FIG. 5B (surrounding tilt latch 540)
512b opening within sealing pad 510b of FIG. 5C (surrounding tilt latch 540)
524a-524b strip(s) of pre-installed weather stripping of FIG. 5A-5B
540 tilt latch
542 tilt latch control mechanism
550 (rear north east) corner of sash 310d
610a sealing pad of FIGS. 6C-6D
614a-614b first portions (appendages) of sealing pad 610a
616a-616b other portions (appendages) of sealing pad 610a
622a weather stripping (white color) disposed in t-slot 638
622b weather stripping (dark color)
630a-630e recessed areas
632a-632c debris
636a-636d surface irregularities
638 t-slot of FIG. 6B

What is claimed is:

1. An article of manufacture for reducing infiltration of matter and/or energy through a window, the article including:
a plurality of filaments that are made at least in part from a first material;
a backing layer that is made, at least in part from said second material; and wherein
said plurality of filaments are attached to said backing layer to form a multi-layer structure, said pile of filaments forming an filament layer and said backing layer forming a support layer of said multi-layer structure, and wherein
said backing layer having an exposed surface that is absent of said attached filaments and designed to be attachable to at least a portion of a surface said surface including that of a window sash, said window sash being configured to be installed within a window, and wherein
a sealing pad, being dimensioned from said multi-layer structure, is dimensioned so that it is attachable within a set of perimeter boundaries that bound a short dimension of said surface of a rail of said window sash, and further dimensioned so that said sealing pad spans at least a minimal distance across said short dimension, and where said minimal distance being equal to at least one half of said short dimension of surface of a rail of said window sash; and wherein
said sealing pad, is designed to provide resistance against infiltration of matter and/or energy along said surface of said window sash, while said window sash is installed within said window.

2. The article of manufacture of claim 1, wherein said exposed surface of said backing layer is attachable to said at least a portion of a surface of a rail of a window sash, via application of an adhesive substance between said exposed surface and said at least a portion of a surface of a rail of a window sash.

3. The article of manufacture of claim 1 wherein said sealing pad is dimensioned so that said exposed surface can be adhered to a surface of a rail of a window sash at a location that is adjacent to a corner of said window sash.

4. The article of manufacture of claim 1 wherein said sealing pad includes said backing layer of sufficient flexibility to make contiguous physical contact with at least a portion of each of two adjacent surfaces of a window sash and wherein said adjacent surfaces are perpendicular to each other.

5. The article of manufacture of claim 4 wherein said adjacent surfaces are intermediate surfaces of a window sash.

6. The article of manufacture of claim 1 including an opening, and wherein said opening is located and dimensioned within said sealing pad to enable a protrusion from said window sash to pass through said opening of said sealing pad, while said sealing pad is attached to said window sash.

7. The article of manufacture of claim 4 wherein said protrusion is a pivot bar of said window sash.

8. The article of manufacture of claim 4 wherein said protrusion is a tilt latch of said window sash.

9. The article of manufacture of claim 1 wherein said first material and said second material are each made at least in part, from polypropylene.

10. The article of manufacture of claim 1, wherein said sealing pad is further dimensioned so that a width dimension of said sealing pad, said width dimension being measured parallel to a short dimension of a window sash surface upon which said sealing pad is installed, equals a value of one inch or greater.

11. The article of manufacture of claim 1 wherein said sealing pad is dimensioned by employing a programmable laser device for cutting through sealing pad material.

12. The article of manufacture of claim 1 wherein said sealing pad is designed to enable value added attachment of said sealing pad to pre-manufactured windows.

13. The article of manufacture of claim 1 where said sealing pad is dimensioned to enable further attachment to another second surface of said window sash.

14. The article of manufacture of claim 1 wherein said minimal distance is equal to at least seventy percent of said depth dimension of said at least one surface of said window sash.

15. The article of manufacture of claim 1 wherein said minimal distance is equal to at least ninety percent of said depth dimension of said at least one surface of said window sash.

16. The article of manufacture of claim 11 wherein an entire perimeter of said sealing pad is not cut, and instead an uncut portion of said perimeter is left uncut within said sealing pad material.

17. The article of manufacture of claim 16 wherein said uncut portion is at least one sixteenth of an inch in length.

18. A method for reducing infiltration of matter and/or energy through a window, the method including the steps of:
acquiring a manufactured window;
performing an infiltration test to detect infiltration of at least some matter and/or energy through said window;
identifying one or more locations along a surface of a rail of a window sash within said window, where infiltration of said matter and/or energy is occurring, as determined in accordance with results said infiltration test; and
attaching at least one sealing pad at a location of one of at least said one or more locations along a surface of a rail of said window sash, in order to reduce infiltration of said matter and/or energy occurring at said location within said window.

19. The method of claim 18, wherein said sealing pad includes an exposed surface and wherein said sealing pad is attachable to said window sash, via application of an adhesive substance between said exposed surface and said surface of said window sash.

20. The method of claim 18 wherein said sealing pad as attached to said location along said surface of a rail of said window sash, spans least a minimal distance across a short dimension of a surface of a rail of said window sash, and wherein said minimal distance is equal to at least one half of said depth dimension of said window sash.

21. The method of claim 18 wherein said sealing pad as attached to said location along said surface of a rail of said window sash, surrounds a corner of said window sash.

22. The method of claim 1 wherein said minimal distance is equal to at least eighty percent of said depth dimension of said at least one surface of said window sash.
